(19) United States
(12) Patent Application Publication
(10) Pub. No.: US 2013/0337140 A1
(43) Pub. Date: Dec. 19, 2013

(54) Sugar Free Fondant and Method for Preparing

(71) Applicant: Jennifer M. Parker, Lawton, OK (US)

(72) Inventor: Jennifer M. Parker, Lawton, OK (US)

(21) Appl. No.: 13/918,811

(22) Filed: Jun. 14, 2013

Related U.S. Application Data
(60) Provisional application No. 61/660,754, filed on Jun. 17, 2012.

(51) Int. Cl. A23G 3/38

(52) U.S. Cl. CPC A23G 3/38
USPC 426/572

(57) ABSTRACT

A sugar free fondant and method of preparing same includes combining gelatin and water to form a solid gel and combining predetermined amounts of Isomalt, Maltitol, salt, and water to form a syrup which is then heated. The syrup and gel are mixed and cooled to form an intermediate portion A. Cornstarch and confectionary Xylitol are combined to form

Intermediate portion B. Intermediate portion A is liquefied through heating and then mixed with intermediate portion B to form sugar free fondant.

### REFERENCE TO RELATED APPLICATIONS

This invention claim the priority of U.S. application No. 61/660,754 filed on Jun. 17, 2012 and titled Sugar Free Fondant.

### BACKGROUND OF THE INVENTION

This invention relates generally to confections and, more particularly, to a sugar free form of fondant—a confection that is traditionally made largely of sugar for covering and decorating specialty cakes.

Sugar free forms of popular dessert foods are well known, including sugar free candies, ice cream, puddings, pies, and cakes. Sugar free cakes, including sugar free frosting, can be made by a home baker from mixes and other ready-to-use products purchased at any grocery store.

Specialty cakes, however, have not significantly entered into the sugar free market, including cakes for weddings, birthdays, anniversaries, and other celebrations. These specialty cakes are often the highlight or center piece of the entire celebration. Indeed, it is the degree of decoration and ornamentation that sets these cakes apart from a traditional cake. A decorated specialty cake typically include a substance called “fondant” to cover or decorate the cake as opposed to icing or frosting.

Fondant, in its simplest form, consists largely of sugar and water. Fondant may be rolled into a flat sheet (also referred to as “rolled fondant” as opposed to “poured fondant”) that may be used to cover the cake and may also be shaped into decorative add-ons such as flowers, ribbons, and other ornamental shapes. The basic ingredients comprising fondant include sugar, gelatin, glycerin (which keeps the sugar pliable and forms a dough-like consistency), and water.

Because fondant consists largely of sugar and water, specialty cakes have not heretofore joined the sugar free movement that is available for cakes routinely made at home. Stated another way, specialty cakes that are almost always covered or decorated with fondant and fondant is made significantly with sugar, a specialty cake cannot be made sugar free even if the underlying cake mix is sugar free.

Therefore, it would be desirable to have a sugar free form of fondant so that specialty cakes covered thereby or decorated therewith could truly be sugar free. Such a product, of course, would be unexpected in that fondant is traditionally made substantially of sugar.

### SUMMARY OF THE INVENTION

A sugar free fondant and method of preparing same includes combining gelatin and water to form a solid gel and combining predetermined amounts of Isomalt, Maltitol, salt, and water to form a syrup which is then heated. The syrup and gel are mixed and cooled to form an intermediate portion A. Cornstarch and confectionary Xylitol are combined to form

Intermediate portion B. Intermediate portion A is liquefied through heating and then mixed with intermediate portion B to form sugar free fondant.

A general object of this invention is to provide a sugar free fondant suitable for covering and decorating specialty cakes.

Another object of this invention is to provide a sugar free fondant that has substantially the same characteristics as traditional fondant and can be used in substantially the same manner.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

Not applicable

### DESCRIPTION OF THE PREFERRED EMBODIMENT

A sugar free fondant and method for its preparation will now be described in detail. Sugar free fondant is made from dry gelatin, water, Isomalt, Maltitol, sodium chloride (salt), shortening, Xylitol, cornstarch, and flavoring. Coloring may also be used as well as artificial sweeteners. Glycerin may also be used. Isomalt is a crystalline substance derived from sucrose that provides stability in cooking and is frequently used in pastries and cake decoration. It is “sugar-like” in its physical properties but without the negative characteristics of traditional sugar such as calories, effect on dental health, and the like. Similarly, Maltitol is a sugar alcohol that possesses desirable sweetness but without the caloric and dentistry negative properties. Xylitol is another sugar alcohol having sweetness characteristics of sugar but without the caloric downside. Sodium chloride, of course, is an ionic chemical compound commonly known as salt and that is used as a condiment and food preservative.

The sugar free fondant may be constituted by the following process steps. It is understood that references to the proportions of each ingredient used at respective steps are preferred but that other proportions may also be effective. The steps may also be performed in a different order than described except as specifically indicated.

The fondant may be prepared by combining one part powdered gelatin with approximately 2.4 parts water and allowed to form a solid gel, and then breaking the solid gel into smaller pieces. A syrup is formed by combining Isomalt (1.5 parts), Maltitol (1 parts), salt (0.004 parts) and water (0.3 parts) and then heating the combination to approximately 240 degrees Fahrenheit. The hot syrup is then mixed with the gel made from the dry gelatin (in a ration of 7.7 parts syrup to 1 part gel) until the product is fluffy. It is understood that flavoring may optionally be added at this point. The process continues by pouring the combined gel and hot syrup into a pan or other container that is dusted with cornstarch. The poured combination is allowed to cool and harden to form a sugar free marshmallow like product (referred to hereinafter as “Intermediate portion A”).

An “Intermediate portion B” is prepared by blending 1 part cornstarch into 16 parts confectionary Xylitol powder. An alternative sweetener such as Sorbitol or any other polyol-based sugar alcohol may also be blended at this time. In addition, a gum powder may be added to Intermediate portion B to increase elasticity. The step of blending is repeated until the mixture is well blended.

The final sugar free fondant is prepared by combining 1 part Intermediate portion A, 2 parts Intermediate portion B, approximately 0.5 parts shortening, and a small amount of water (less than 0.1 parts). A small amount of glycerin (less than 0.1 parts) may also be included. First, Intermediate portion A is liquefied by heating with the small amount of water in a container coated with approximately half of the shortening. The melted Intermediate portion A is then stirred into 1 part of the Intermediate portion B in a container coated with the remainder of the shortening until well mixed. The process continues by adding 1 part of Intermediate portion B to the mixture and stirring until the product takes on a dough like consistency. At this juncture, the sugar free fondant is substantially prepared.

The process of preparation concludes by wrapping the final product in plastic wrap or the like to reduce contact with air and allowing the product to cool. When cooled the sugar free fondant can then be rolled out to cover or decorate cakes. It is understood that gum paste may be added to form a substance suitable for molding flowers, or other geometrical figures with which to decorate a cake.

Accordingly, a sugar fondant may be prepared that possesses the sweetness, stability, usability as traditional sugar based fondant but without the negative effects of sugar, such as high calories and contribution toward cavity formation in a user's teeth.

It is understood that while certain forms of this invention have been illustrated and described, it is not limited thereto except insofar as such limitations are included in the following claims and allowable functional equivalents thereof.

1. A method for preparing a sugar free fondant, comprising the steps:
combining one part powdered gelatin with 2.4 parts water so as to form a solid gel;
combining 1.5 parts Isomalt, one part Maltitol, 0.004 parts salt, and 0.3 arts water to form a syrup;
heating said syrup to about 240 degrees (F.);
mixing said heated syrup with said solid gel and allowing said syrup-gel mixture to cool so as to form intermediate portion A;
blending 1 part cornstarch and 16 parts confectionary Xylitol powder to form intermediate portion B;
liquefying said intermediate portion A through heating; and
mixing said liquefied intermediate portion A with intermediate portion B.

2. The method as in claim 1, further comprising the step of breaking said solid gel into multiple pieces prior to mixing said solid gel with said heated syrup.

3. The method as in claim 2, wherein said step of mixing said heated syrup with said solid gel is at a ratio of about 7.7 parts said heated syrup to 1 part said solid gel, said step of mixing being repeated until the mixture thereof is fluffy.

4. The method as in claim 3, further comprising the step of adding flavoring to the mixture of said solid gel and said heated syrup.

5. The method as in claim 3, further comprising the step of pouring the mixture of said solid gel and said heated syrup into a pan dusted with cornstarch during said step of allowing said mixture to cool.

6. The method as in claim 1, wherein said intermediate portion A is a marshmallow type product.

7. The method as in claim 1, wherein said step of liquefying said intermediate portion A includes heating said intermediate portion A in a pan that is coated with shortening and that includes a small amount of water.

8. The method as in claim 7, wherein said step of mixing said liquefied intermediate portion A with intermediate portion B includes:
stirring one part said liquefied intermediate portion A into a first portion of said intermediate portion B in a container with shortening; and
subsequently stirring a remainder of said intermediate portion B into the already mixed said intermediate portion A and said intermediate portion B to form a doughy product.

9. The method as in claim 8, comprising the steps:
wrapping said doughy product in plastic wrap to reduce contact with air; and
allowing said wrapped product to cool; and
rolling out said doughy product, when cool, whereby to cover or decorate a cake.

10. A sugar free fondant prepared by a process comprising the steps:
combining one part powdered gelatin with 2.4 parts water so as to form a solid gel;
combining 1.5 parts Isomalt, one part Maltitol, 0.004 parts salt, and 0.3 parts water to form a syrup;
heating said syrup to about 240 degrees (F.);
mixing said heated syrup with said solid gel and allowing said syrup-gel mixture to cool so as to form intermediate portion A;
blending 1 part cornstarch and 16 parts confectionary Xylitol powder to form intermediate portion B;
liquefying said intermediate portion A through heating; and
mixing said liquefied intermediate portion A with intermediate portion B.

11. The method as in claim 10, further comprising the step of breaking said solid gel into multiple pieces prior to mixing said solid gel with said heated syrup.

12. The method as in claim 11, wherein said step of mixing said heated syrup with said solid gel is at a ratio of about 7.7 parts heated syrup to 1 part solid gel, said step of mixing being repeated until the mixture thereof is fluffy.

13. The method as in claim 12, further comprising the step of adding flavoring to the mixture of said solid gel and said heated syrup.

14. The method as in claim 12, further comprising the step of pouring the mixture of said solid gel and said heated syrup into a pan dusted with cornstarch during said step of allowing said mixture to cool.

15. The method as in claim 10, wherein said intermediate portion A is a marshmallow type product.

16. The method as in claim 10, wherein said step of liquefying said intermediate portion A includes heating said intermediate portion A in a pan that is coated with shortening and that includes a small amount of water.

17. The method as in claim 16, wherein said step of mixing said liquefied intermediate portion A with intermediate portion B comprises:
stirring one part said liquefied intermediate portion A into a first portion of said intermediate portion B in a container with shortening; and
subsequently stirring a remainder of said intermediate portion B into the already mixed said intermediate portion A and said intermediate portion B to form a doughy product.

18. The method as in claim 17, comprising the steps:
wrapping said doughy product in plastic wrap to reduce contact with air; and
allowing said wrapped product to cool;
rolling out said doughy product, when cool, whereby to cover or decorate a cake.

19. A method for preparing a sugar free fondant, comprising:
combining a powdered gelatin with water so as to form a solid gel;
combining Isomalt, Maltitol, salt, and water to form a syrup;
heating said syrup to about 240 degrees (F.);
mixing said heated syrup with said solid gel and allowing said syrup-gel mixture to cool so as to form intermediate portion A;
blending cornstarch and confectionary Xylitol powder to form intermediate portion B;
liquefying said intermediate portion A through heating; and
mixing said liquefied intermediate portion A with intermediate portion B.

20. The method as in claim 19, wherein:
said step of liquefying said intermediate portion A includes heating said intermediate portion A in a pan that is coated with shortening and that includes a small amount of water;
said step of mixing said liquefied intermediate portion A with intermediate portion B comprises:
stirring one part said liquefied intermediate portion A into a first portion of said intermediate portion B in a container with shortening; and
subsequently stirring a remainder of said intermediate portion B into the already mixed said intermediate portion A and said intermediate portion B to form a doughy product.
